(19) United States
(12) Patent Application Publication
(10) Pub. No.: US 2017/0250587 A1
(43) Pub. Date: Aug. 31, 2017

(54) LINEAR MOTOR

(71) Applicant: ANCA Pty Ltd, Bayswater North, Victoria (AU)

(72) Inventors: Pat McCluskey, Bayswater North, Victoria (AU); Philip Wysocki, Bayswater North, Victoria (AU); Tim Haar, Bayswater North, Victoria (AU)

(21) Appl. No.: 15/505,172

(22) PCT Filed: Jul. 24, 2015
(86) PCT No.: PCT/AU2015/000438

§ 371 Date: Feb. 20, 2017

(30) Foreign Application Priority Data
Aug. 22, 2014 (AU) 2014903318

(51) Int. Cl. H02K 5/20; H02K 9/19; H02K 9/10; H02K 41/03

(52) U.S. Cl. CPC H02K 5/20; H02K 41/031; H02K 9/19; H02K 9/10

(57) ABSTRACT

A linear motor (30), including a mover and a stator, the mover having a cylindrical body (33) that forms an elongate circular bore (31) and the stator being an elongate shaft disposed within the bore. The cylindrical body (33) includes a plurality of electrical windings (32) and the shaft includes a synchronous or variable reluctance topology, or a plurality of magnets. Electrical energising of the windings (32) results in relative movement and/or force generation between the cylindrical body (33) and the shaft. The cylindrical body (33) being disposed within a housing (37) with a coolant space (35) being formed between the cylindrical body (33) and an internally facing cylindrical surface (38) of the housing (37). The coolant space (35) being formed along at least a major portion of the length of the cylindrical body (33) and the coolant space (3) being substantially cylindrical and of substantially constant cross-section.

### TECHNICAL FIELD

The present invention relates to a linear motor.

### BACKGROUND OF INVENTION

Linear motors are widely used in a variety of machines and devices. Forms of linear motors include flat-bed linear motors and tubular linear motors. Linear motors provide direct linear movement, as opposed to linear movement provided by rotary motors that convert rotary movement to linear movement such as though gears or screws, belts or pulleys. Elimination of devices to convert rotary movement to linear movement reduces the complexity and cost of drive arrangements. Linear motors can operate at very high speeds and with high acceleration. Linear motors also are very reliable given that they have few moving parts and are highly accurate and can operate with low vibration.

Linear motors include a forcer or mover and a stator. The mover is the moving part of the motor and the stator is stationary. The mover includes coils and the stator is magnetic or magnetic field reactive such as including magnets, so that when the coils are energised, relative movement and/or force between the mover and stator takes place.

A typical linear motor includes a housing that is square in cross-section and that includes a central bore that circular. The housing includes windings wound around the bore. A shaft of circular cross-section extends through the bore and projects out either end. The shaft houses the magnets (if they are used). Either of the housing or the shaft can be fixed so that the other of the housing or the shaft can move or provide force. The resultant movement and/or force is linear.

Linear motors produce heat as they operate, so that they often include a coolant system to dissipate heat. In some prior art arrangements, the coolant system includes coolant attachments that are applied to one or more surfaces of the housing and coolant passes through the attachments to dissipate heat. In some arrangements, a coolant attachment is applied to one side of the square housing and extends for the length of the housing. In other arrangements, a coolant attachment is applied to two or more sides of the housing and each attachment extends for the length of the housing. It is not normal for a coolant attachment to be applied to all four sides of the housing, given that often the housing has external fittings or connections, such as components for mounting it to machinery or devices and accordingly, often the coolant attachment is applied to only one or two of the housing sides. This means that the coolant attachment or attachments can be less effective in dissipating heat that is generated in sections of the linear motor that are spaced or remote from where the coolant attachment or attachments are applied.

See for example FIG. 1, in which a schematic cross-sectional illustration of a prior art linear motor 10 is shown. The linear motor 10 has a square housing 11 enclosing a circular coil or winding 12. A coolant attachment 13 is applied to the top wall 14 of the housing 11. In FIG. 1, it can be seen that the bottom wall 15 is spaced furthest from the coolant attachment 13. It follows that heat generated in the winding 12 adjacent the bottom wall 15 is less easily dissipated than heat generated adjacent the top wall 14, or adjacent the side walls 16 or 17.

Also, even in the sections of a linear motor that are proximate a coolant attachment, the spacing between the coils and the external side walls of the housing varies. For example, FIG. 1 shows that the winding 12 is spaced from the top, bottom and side walls of the housing 11 a greater amount at the corners of the housing 11 than intermediate the corners shown, so that dissipation of heat even on walls of the housing on which coolant attachments are provided can vary.

Thus, in some forms of the prior art, heat generated in the linear motor is not evenly dissipated and in addition, there can be large thermal variation in the heat generated within the motor, both of which can affect thermally sensitive components in the immediate vicinity of the linear motor. This is a particular problem where the linear motor is employed in high precision machinery, such as high precision grinding and milling machinery, where even small temperature fluctuations can affect the accuracy of the machinery.

Linear motors are also more efficient than other actuators such as ball screws and their use would be preferred if the heat they generate can be adequately dissipated.

Linear motors can also be difficult to mount to machinery and devices. Most linear motors known to the applicant are “face mountable” which means that a face of the housing of the motor mounts against a face of the machinery with which the motor is to be used. FIG. 2 illustrates such a mounting and shows a linear motor 20 with a rectangular housing 21 of square cross-section and an elongate shaft 22 extending through the housing 21. The hatched housing surface 23 forms a mounting face and includes four threaded openings 24 for receiving fasteners to fix the linear motor 20 to a machine. Four further threaded openings 26 (only three of which are visible in FIG. 2) are formed on the front surface 27 of the housing 21 for fixing the linear motor 20 to a machine from the front surface. While either of the surfaces 23 or 27 provides secure fixing, ready access to the fasteners that secure the linear motor 20 to the machinery is not often provided, so that installation and removal of the linear motor 20 from the machinery is not easy.

It is an object of the invention to overcome or at least alleviate one or more of the difficulties associated with prior art arrangements.

### SUMMARY OF INVENTION

In one embodiment of the invention there is provided a linear motor that includes a mover and a stator, the mover having a cylindrical body that forms an elongate circular bore and the stator being an elongate shaft disposed within the bore, the cylindrical body including a plurality of electrical windings and the shaft including a synchronous or variable reluctance topology, or including a plurality of magnets, whereby electrical energising of the windings results in relative movement or force generation between the cylindrical body and the shaft, the cylindrical body being disposed within a housing with a coolant space being formed between the cylindrical body and an internally facing cylindrical surface of the housing, the coolant space being formed along at least a major portion of the length of the cylindrical body, the coolant space being substantially cylindrical and of substantially constant cross-section.

A linear motor of the above kind is envisaged to provide advantages over the prior art because it provides for even heat dissipation about the windings. That is, the cylindrical coolant space encircles the windings in a manner that the spacing between the windings and the coolant space is constant, or in other words, the proximity of the windings to the coolant space is constant or does not vary. Advantageously, this means that all sections of the windings are cooled equally so that the linear motor does not generate greater heat in some parts of the motor than in others. This allows a linear motor according to the invention to be installed more readily in the immediate vicinity of thermally sensitive components either without affecting the operation of those components, or affecting those components in a more predictable manner. Either outcome is advantageous given that if the thermal effect on components in the immediate vicinity of the linear motor is negligible or predictable as a result of employing the present invention, design of machinery or equipment that employs the linear motor can be less difficult. Moreover, the advantages that flow from the use of linear motors can be achieved in machinery or equipment that would otherwise not be able to use linear motors because of the difficulties associated with prior art linear motors.

A linear motor according to the invention can also be of more compact shape than prior art linear motors because the shape of the housing can be more compact by the absence of coolant attachments of the above described kind. Moreover, the cylindrical body of the linear motor can be arranged to fit into existing actuator housings such as ball screw housings, by sliding the cylindrical body into the housing after suitable modification of the housing as might be required, such as after increasing the internal diameter of the housing. This means that retrofit is possible, thereby allowing the advantages that flow from the use of linear motors to be embodied in machinery or equipment that previously used other forms of drive.

For example, because of improved dissipation of heat and ease of retrofit, a linear motor according to the invention is expected to enable relatively easy replacement of existing ball screws actuators, for improved performance.

The coolant arrangement discussed above can form a thermal barrier between the linear motor and surrounding components. By the complete encirclement of the windings by the coolant space (which is substantially cylindrical), thermal transfer from the linear motor can be minimised, or even be negligible. This again differs from the prior art which employs a coolant attachment applied to just one side of a square housing, or even two or three sides of the housing, whereby thermal escape can occur through sides of the housing that do not have a coolant attachment.

In addition, in a linear motor according to the present invention, an insulation layer can be positioned within the coolant space, such as against the internally facing cylindrical surface of the housing, for the purpose of reducing thermal transfer from the coolant space to outside the linear motor. This is appropriate where the coolant system of the linear motor is capable of removing all, or substantially all of the generated heat which is captured within the coolant space. The insulation layer should be of low thermal conductivity. The insulation layer can be made of rubber or ceramic for example. Other possibilities include plastics, composites (fibre glass, G11, carbon fibre) or epoxy.

Still further, the opposite ends of the linear motor can be made of a thermal and/or electrically insulated layer or material to form a thermal and/or conductive barrier at each end of the motor and thus to further capture generated heat in the coolant space. The thermal and/or electrically insulated layer or material can be made of the same materials as listed above in relation to the insulation layer.

The coolant space can be formed in any suitable manner. In some forms of the invention, the windings of the cylindrical body are located within a cylinder that extends for the length of the windings and the coolant space is formed on the opposite side of the cylinder to the windings. In this form of the invention, the cylindrical housing extends about the cylinder and is spaced from the cylinder to form the coolant space. The cylinder can be formed from aluminium or other suitable metal, or other non-magnetic material. The cylinder can be in contact with the outer surface of the windings, or as close to the surface as possible, so that heat from the windings is conducted directly to the cylinder for dissipation into the coolant space. In some forms of the invention, the windings are immersed or embedded in a resin, such as an epoxy resin, and the cylinder can be in contact with the resin coating of the outermost windings.

In the above form of the invention in which the windings of the cylindrical body are located within a cylinder, the cylindrical body can be provided without a housing for later insertion into a housing. This can be suitable for example where the housing is an integral part of a machine, such as part of a cast part of a machine. This can also be suitable where the linear motor of the invention is being employed to replace a ball screw and the housing of the ball screw is to be used (perhaps with some modification) to house the cylindrical body. The invention therefore extends to a cylindrical body as described herein as a separate component to the housing, but which is configured to interact with a housing in the manner described. The present invention is unique in this respect, in that no linear motor known to the applicant can be inserted into an existing housing in the manner proposed in the present invention.

The coolant space can have at least one inlet and outlet so that coolant can be introduced into the coolant space through the inlet and discharged through the outlet. The coolant can be cooled before reintroduction into the coolant space via the inlet or the coolant can be of a kind which is not reused, water for example.

The coolant space can be open throughout its length, or it can include passageways, or disturbances to direct or disrupt the flow of coolant through the coolant space, or to make the flow turbulent. In some forms of the invention, the coolant space can include a spiral or helix so that coolant flows between the inlet and outlet in a spiral or helix path. This increases the time that the coolant will spend in the coolant space before it reaches the outlet.

Alternatively, the coolant space can include projections that the coolant is required to flow about between the inlet and the outlet. Other structures include fins that extend lengthwise of the linear motor. The fins can direct coolant between a pair of adjacent fins in one direction only, or the fins can be constructed for return movement of the coolant along an adjacent pair of fins. The coolant can be liquid or gas, although liquid is most likely.

In other embodiments of the invention there is provided a linear motor that includes a mover and a stator, the mover having a cylindrical body that forms an elongate circular bore and the stator being an elongate shaft disposed within the bore, the cylindrical body including a plurality of electrical windings and the shaft including a synchronous or variable reluctance topology, or including a plurality of magnets, whereby electrical energising of the windings results in relative movement and/or force generation between the cylindrical body and the shaft, the cylindrical body being disposed within a housing that has opposite first and second ends, whereby the cylindrical body includes a flange for attachment to one of the first and second ends for mounting the cylindrical body within the housing.

The use of a flange formed at one of the first and second ends allows the linear motor to be securely fixed in place, but in addition, allows ready access to the fasteners that secure the linear motor to the machinery. This means that installation and removal of the linear motor from the machinery is easier than in prior art linear motor that employ face mountings.

In the embodiment of the invention in which the housing includes a flange formed at one of the first and second ends for mounting the housing to a machine, the housing can be a cylindrical housing, or it can be a square housing in accordance with linear motors of the prior art which also employ face mountings. In either forms, the benefits of improved access to fasteners for installing and removing the linear motor are provided.

### BRIEF DESCRIPTION OF DRAWINGS

In order that the invention may be more fully understood, some embodiments will now be described with reference to the figures in which:

FIG. 1 shows schematically in cross-section, a prior art linear motor arrangement with a coolant attachment.

FIG. 2 shows a prior art linear motor with a face mounting arrangement.

FIG. 3 is a cross-sectional view of a linear motor according to one embodiment of the invention.

FIG. 4 is an exploded view of a linear motor according to one embodiment of the invention for installation in a machine component.

FIG. 5 is a view of a cylindrical body for use in a linear motor according to the invention.

FIG. 6 is an alternative view of a cylindrical body for use in a linear motor according to the invention.

FIG. 6a is a detailed view of a portion of the cylindrical body of FIG. 6.

### DETAILED DESCRIPTION

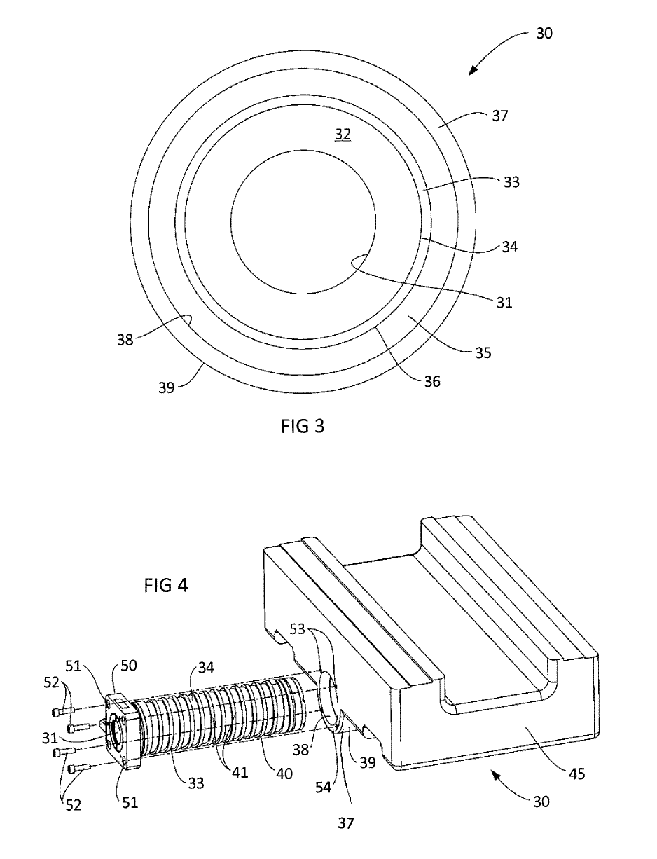

With reference to FIG. 3, a cross-sectional view of a linear motor 30 is illustrated where the cross-section is taken perpendicular to the lengthwise axis of the motor. The motor 30 includes an elongate circular bore 31 defined by electrical windings 32 (copper windings for example) and a cylinder or cylindrical body 33 which is shown in touching engagement with the outer face 34 of the windings 32, but which could, in alternative embodiments, be slightly spaced from the outer surface 34.

A coolant space 35 encircles the body 33 and forms a space within which coolant can flow to dissipate heat which is generated by the windings 32. The coolant can be liquid or gas, although liquid is most likely. The coolant space 35 is defined between the outer surface 36 of the body 33 and the facing inner surface 38 of the cylindrical housing 37. In FIG. 3, the housing 37 is shown as cylindrical on the inner surface 38 as well as the outer surface 39. However, it should be appreciated that the shape of the housing in respect of the outer surface is not particularly important to the invention, and for example, the housing could be square or rectangular as an example, or otherwise shaped. Likewise, the outer surface could include fins for heat dissipation, mounting lugs or a variety of other fittings such as might be required to fix the housing in place relative to a machine or machine component.

An insulation layer can be positioned within the coolant space against the inner surface 38 of the housing 37. The insulation layer can have low thermal conductivity and can be made of rubber or ceramic for example. The insulation layer will reduce thermal transfer from the coolant space 35 through the housing 37 to outside the linear motor 30.

The linear motor 30 would also include an elongate shaft which is disposed closely within the bore 31. In forms of the invention not limited to that illustrated in the drawings, the shaft could be a hollow shaft which is non-magnetic, and which includes a plurality of magnets, such as rare earth magnets, and in some forms of the invention, these can be spaced apart by steel spacers. The shaft can include magnets that are assembled side by side with the magnet polarity reversed. In some arrangements, two or more magnets would be placed side by side with the magnet polarity in the same direction, and then a next set of magnets would be assembled adjacent the first set with the polarity in the opposite direction. Spacers can be interposed between the adjacent magnets or the adjacent sets of magnets. In this arrangement in respect of FIG. 3, when the windings 32 are energised, either the shaft will move within the bore 31, or if the shaft is fixed, the windings 32 and the other components described as extending about the windings 32 would all move relative to the shaft. Control of the energisation of the windings 32 results in control of the relative movement and/or force between the shaft and the windings.

The coolant space 35 forms a space within which coolant can flow between an inlet and an outlet for the purpose of dissipating heat which is generated within the windings 32. The cylindrical housing 37 effectively forms a cooling jacket to confine coolant to between the outer surface 36 of the body 33 and the inner surface 38 of the housing 37. The inlet and outlet that facilitates ingress and egress of coolant from within the coolant space 35 can be placed in any suitable position and take any suitable form. The coolant can be injected into the coolant space 35 through a port under pressure, or it can be gravity fed.

The coolant space 35 is shown in FIG. 3 as being an open space. While this is acceptable, a preferred arrangement is illustrated in FIG. 4, in which a helix or spiral formation 40 extends along the length of the body 33 and which creates a spiral or helical path along the length within which coolant can flow. This can increase the time taken for coolant to exit the coolant space 35, and can thus allow the coolant within the space 35 to absorb a greater amount of heat for dissipation. Alternative arrangements to such a helical or spiral formation include a series of parallel and spaced apart cylindrical flanges or fins, that include openings or breaks, to allow coolant to flow through the flanges or fins between opposite ends of the linear motor. These arrangements can be used with liquid or air cooling. Other arrangements could be employed to create a convoluted path within the coolant space 35, for the purpose of slowing the speed of flow through the coolant space, creating a turbulent flow, or for ensuring that coolant uniformly flows completely about the coolant space 35 and thus about the windings 32.

What is important, is that the inner surface 38 be substantially cylindrical, so that the coolant space 35 is also formed to be substantially cylindrical and of substantially constant cross-section throughout the length of the windings 32 despite the existence of a helical or spiral formation or flanges or fins as discussed above.

With reference to FIG. 4, the cylindrical body 33 is illustrated removed from the cylindrical housing 37, in order to illustrate the spiral 40 which is formed on the outer surface 36 of the cylindrical body 33. The outer surface 41 of the spiral 40 is at a height which is a very close fit against or close to the inner surface 38 of the housing 37. This close fit is intended to prevent leakage of coolant fluid past the spiral 40, over the top of the outer surfaces 41. While some leakage can be tolerated, the intention is that the majority of the cooling fluid takes a spiral path from one end of the linear motor 30 to the other, along the spiral 40.

Not evident in FIG. 4, is the windings 32, which are radially within the cylindrical body 33.

Also not evident in FIG. 4, is an insulation layer applied to the inner surface 38 of the housing 37, for the purpose of reducing thermal transfer from the coolant space 35 to outside the linear motor 30.

FIG. 4 also illustrates a machine component 45 to which the cylindrical housing 37 has been formed integrally. Inner surface 38 and outer surface 39 of the housing 37 are also identified in FIG. 4.

Alternative to the FIG. 4 arrangement, the housing 37 could be attached by suitable fasteners to the machine component 45, such as to an end or underneath surface.

The other components of the linear motor 30 have been assembled externally of the housing 37 and in FIG. 4, are ready for insertion into the housing 37. FIG. 4 conveniently illustrates that the outer surface 39 of the housing 37 is not required to be cylindrical, but rather, can include a shape or profile suitable for attachment to the machine component 45 and suitable for the attachment of other components to the housing 37, such as coolant inlet and outlet ports.

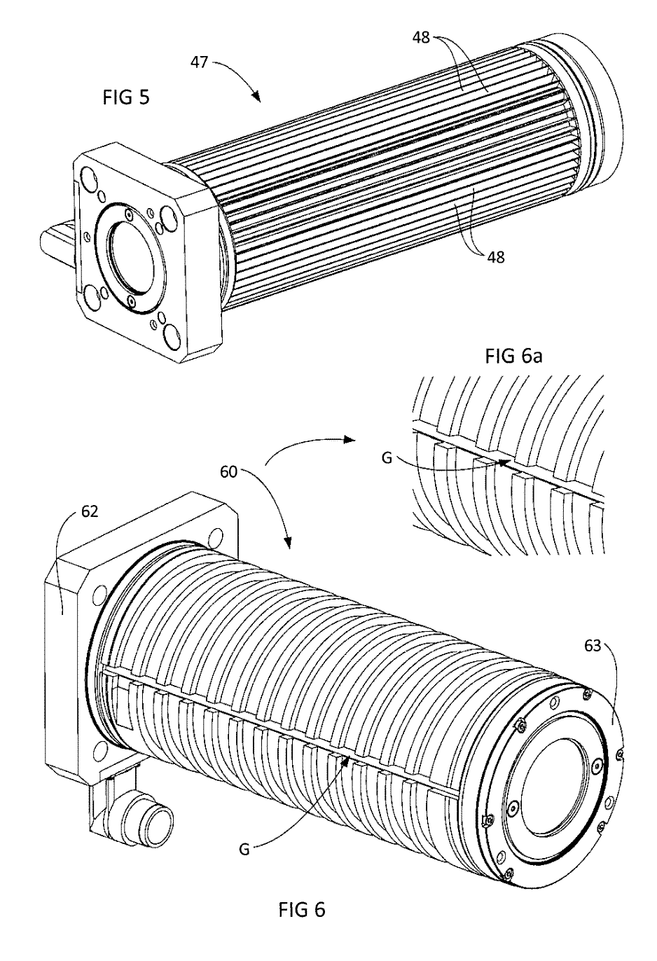

FIG. 5 illustrates a form of cylindrical body 47 which is very similar to the cylindrical body 33 of FIG. 4, but illustrates the use of fins 48 that extend lengthwise of the body 47. The fins 48 direct coolant between a pair of adjacent fins in one direction only (axially in the embodiment illustrated), but the fins can be constructed for return movement of the coolant along an adjacent pair of fins by terminating some of the fins prior to their illustrated end points.

Returning to FIG. 4, this also illustrates an example of the second embodiment of the invention, in which the linear motor 30 includes a mounting flange 50, that is attached to one end of the cylindrical body 33 and which includes screw openings 51 for receipt of screws 52 for threaded engagement within threaded openings 53 of the mounting face 54 of the housing 37. Alternatives to the screws 52 include the use of studs, welding or gluing. The illustrated arrangement enables the secure fixing of the cylindrical body 33 and associated components within and to the housing 37, and thus to the machine component 45. It will readily be appreciated, that in the arrangement shown, access to the screws 52 is easily facilitated, as compared to the arrangement of FIG. 2, where screw access can be more difficult.

Clearly the shape of the flange 50 could take other forms and a greater or lesser number of screw openings and screws could be employed.

FIGS. 6 and 6a illustrate a cylindrical body 60 which is very similar to the cylindrical body 33 of FIG. 4, but which includes a longitudinal slit or gap G completely through the body 60 between the opposite ends 62 and 63 (see FIG. 6a for better illustrating the gap G). This form of cylindrical body eliminates the formation of electromagnetic induction in the cylindrical body 60, so that a magnetic field that would otherwise oppose relative movement between the mover and the stator of the linear motor is not developed. In other words, in a linear motor according to the invention, the cylindrical body can be formed circular but be split longitudinally to prevent electromagnetic induction (large eddy current) which advantageously will eliminate large cogging forces for high speed application.

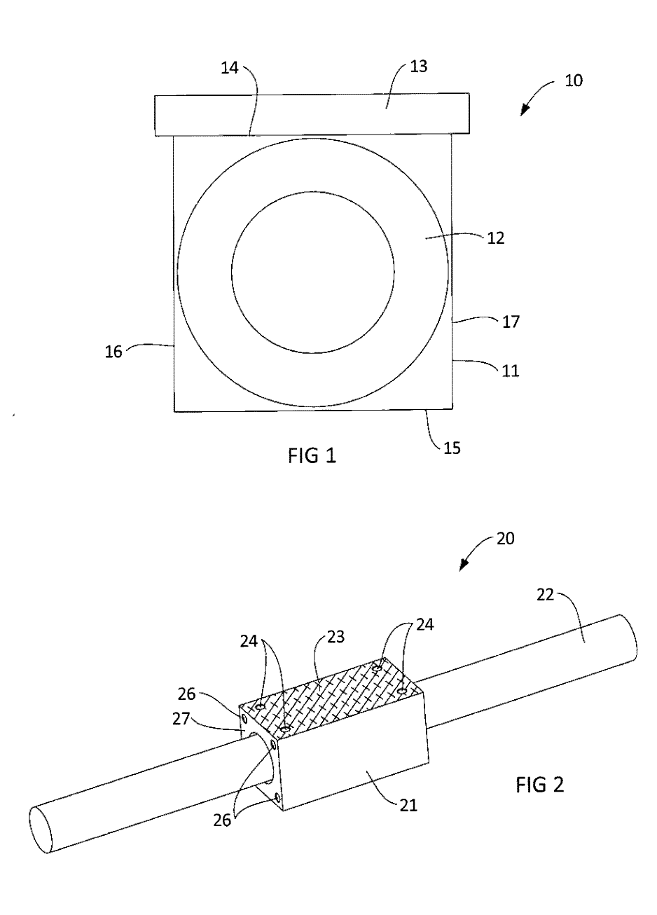

It will be appreciated from the construction of the linear motor 30 of FIGS. 3 and 4 that the motor 30 can provide for even heat dissipation about the full circumference of the windings 32. Moreover, by the arrangement disclosed, the coolant space forms a thermal barrier between the linear motor 30 and other machine components, such as the machine component 45. Thus, where machine components are thermally sensitive, the heat generated by the linear motor 30 does not build up or remain in place to affect those components. The use of the insulation layer as described above in contact with the inner surface of the housing 37 will assist this, as will the use of a thermal barrier at each end of the motor 30. Still further, the provision of the spiral 40 formed as an integral part of the cylindrical body 33 (formed by machining or casting for example), permits the coolant space 35 to be easily integrated into the linear motor 30. This contrasts with the prior art, in which a coolant attachment is attached to a wall of the housing of a linear motor (as shown in FIG. 1), with the consequential disadvantages as described above.

The linear motor which is disclosed in FIGS. 3 and 4 is expected to increase the force output for a prior art motor of the same size. This occurs because force output is relative to the amount of current drawn by the motor. As the current and force is increased, so is the heat. If a portion of the heat is removed, the current, can be increased because the difficulties associated heat build-up are not realised.

Moreover, the disclosed arrangement which employs the mounting flange 50 is also expected to enable the linear motor of the invention to replace ball screws and ball nuts that are also flange mounted, for improved performance.

The coolant that can be used with a linear motor according to the invention and including according to the embodiments of FIGS. 3 and 4 can be a cooling liquid of any suitable form, or alternatively, air cooling could be employed. As described above, the coolant path need not be necessarily take a helix or spiral form, but rather, the coolant space can simply be an open cylindrical space, or can include projections, fins or other disruptors or disturbances to alter the direction of flow through the coolant space, or to create turbulence in that flow.

The invention advantageously integrates a coolant space or jacket into a linear motor and in an alternative form, provides for flange mounting. Each of these improvements is particularly suited to the use of linear motors in the machine tool industry. Linear motors have not been employed in common practice in the machine tooling industry to date, despite the advantages they provide, given that linear motors are disadvantageous in terms of the heat output they give and the difficulty in their mounting. The heat output of linear motors is particularly problematic for high precision machines, particularly where those machines are required to provide highly accurate repeatability. In that type of machine, thermal growth in components of the machine as a result of heat output from a linear motor cannot be tolerated. Where linear motors have been implemented in the machine tooling industry, the poor thermal dissipation provided to date has led to the requirement for separate chiller systems to be employed to minimise heat transfer between the motor and the machine components. Disadvantageously, this adds cost and complexity.

The invention described herein is susceptible to variations, modifications and/or additions other than those specifically described and it is to be understood that the invention includes all such variations, modifications and/or additions which fall within the spirit and scope of the present disclosure.

Throughout the description of this specification the word “comprise” and variations of that word, such as “comprises” and “comprising”, are not intended to exclude other additives or components or integers.

1. A linear motor, including a mover and a stator, the mover having a cylindrical body that forms an elongate circular bore and the stator being an elongate shaft disposed within the bore, the cylindrical body including a plurality of electrical windings and the shaft including a synchronous or variable reluctance topology, or including a plurality of magnets, whereby electrical energising of the windings results in relative movement and/or force generation between the cylindrical body and the shaft, the cylindrical body being disposed within a housing with a coolant space being formed between the cylindrical body and an internally facing cylindrical surface of the housing, the coolant space being formed along at least a major portion of the length of the cylindrical body, the coolant space being substantially cylindrical and of substantially constant cross-section.

2. A linear motor according to claim 1, the cylindrical body including a cylinder and the windings being located within the cylinder, the coolant space being formed on the opposite side of the cylinder to the windings.

3. A linear motor according to claim 2, the cylinder being in contact with the outer surface of the windings so that heat from the windings is conducted directly from the windings to the cylinder for dissipation into the coolant space.

4. A linear motor according to claim 2, the windings being immersed in a resin and the cylinder being in contact with the resin at the outermost surface of the windings.

5. A linear motor according to claim 2, the cylinder being spaced from the outer surface of the windings to create a cylindrical gap between the facing surfaces of the cylinder and the windings.

6. A linear motor according to claim 1, an insulation layer being applied to the internally facing cylindrical surface of the housing, the insulation layer being of low thermal conductivity.

7. A linear motor according to claim 1, the opposite ends of the linear motor being made of a thermal insulated layer or material to form a thermal barrier at each end of the motor.

8. A linear motor according to claim 1, the opposite ends of the linear motor being made of an electrically insulated layer or material to form a conductive barrier at each end of the motor.

9. A linear motor according to claim 1, the coolant space including an inlet and an outlet.

10. A linear motor according to claim 1, the coolant space being open throughout its length.

11. A linear motor according to claim 1, the coolant space including passageways, or disturbances to direct or disrupt the flow of coolant through the coolant space.

12. A linear motor according to claim 1, the coolant space including a spiral or helix to direct coolant flow between the inlet and outlet in a spiral or helix path.

13. A linear motor according to claim 1, the cylindrical body being split longitudinally between opposite ends of the cylindrical body to form a longitudinal gap in the cylindrical body to prevent electromagnetic induction.

14. A linear motor according to claim 1, the housing having opposite first and second ends and the cylindrical body including a flange for attachment to one of the first and second ends for mounting the cylindrical body within the housing.

15. A linear motor, including a cylindrical body that forms an elongate circular bore and an elongate shaft disposed within the bore, the cylindrical body including a plurality of electrical windings and the shaft including a plurality of magnets, whereby electrical energising of the windings results in relative movement between the cylindrical body and the shaft, the cylindrical body being disposed within a housing that has opposite first and second ends, whereby the cylindrical body includes a flange for attachment to one of the first and second ends for mounting the cylindrical body within the housing.
